(19) United States
(12) Patent Application Publication
(10) Pub. No.: US 2010/0146570 A1
(43) Pub. Date: Jun. 10, 2010

(54) WEB SERVICE GATEWAY FOR IPTV SERVICE AND METHOD OF OPERATING THE SAME

(75) Inventors: Hwa Suk KIM, Daejeon (KR); Hyun Jin LEE, Daejeon (KR); Kee Seong CHO, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/562,655

(22) Filed: Sep. 18, 2009

(30) Foreign Application Priority Data
Dec. 10, 2008 (KR) 10-2008-0125416
Apr. 13, 2009 (KR) 10-2009-0031916

(51) Int. Cl. H04N 7/173

(52) U.S. Cl. 725/109

(57) ABSTRACT

A Web service gateway for an IPTV service is provided. The Web service gateway for an IPTV service includes: an IPTV request notification processor for transmitting, when IPTV service progress information is transmitted from an IPTV network, IPTV request notification corresponding to the progress information to a content provider server; an IPTV service request processor for controlling, when a request for an IPTV service is transmitted from the content provider server, the IPTV network so that the requested IPTV service is transmitted to an IPTV terminal; an information request processor for receiving, when information related to the IPTV service is requested from the content provider server, information requested from the IPTV network and transmitting the information to the content provider server; and an execution request processor for transmitting, when an execution request related to the IPTV service is transmitted from the content provider server, the execution request to the IPTV network. Therefore, by using a Web-based content provider, various IPTV services can be provided.

### CROSS-REFERENCE TO RELATED APPLICATION

This application claims the benefit of Korean Application No. 10-2008-0125416, filed Dec. 10, 2008, and Korean Application No. 10-2009-0031916 filed on Apr. 13, 2009, in the Korean Intellectual Property Office, the disclosure of which is incorporated herein by reference.

### BACKGROUND OF THE INVENTION

1. Field of the Invention

The present invention relates to a Web service gateway for an IPTV service and a method of operating the same, and more particularly, to a Web service gateway for an IPTV service and a method of operating the same that can provide a content from a Web-based content provider to a user through an IPTV network in an IMS-based IPTV service.

2. Description of the Related Art

As an IPTV service is widely used, it is requested that various Web-based contents as well as a Video On Demand (VOD) service or a channel broadcasting service are provided using an IPTV service.

In general, in an IPTV service system, an IPTV provider provides an IPTV service in which a quality is guaranteed, a fee is collected, and integration certification is performed through an IPTV network. However, it is difficult to develop all application services related to the IPTV service within an IPTV network.

Application services in which external content providers of the IPTV network provide increase.

Therefore, a method of providing contents provided by external content providers of the IPTV network to users using the IPTV network is requested.

### SUMMARY OF THE INVENTION

The present invention has been made in an effort to solve the above problems, and the present invention provides a Web service gateway for an IPTV service and a method of operating the same that can provide a Web-based content to a user through an IPTV network by providing a Web service gateway between an IPTV provider and a Web-based content provider.

According to an aspect of the present invention, there is provided a Web service gateway for an IPTV service, including: an IPTV request notification processor for transmitting, when IPTV service progress information is transmitted from an IPTV network, IPTV request notification corresponding to the progress information to a content provider server; an IPTV service request processor for controlling, when an IPTV service request is transmitted from the content provider server, the IPTV network so that the requested IPTV service is transmitted to an IPTV terminal; an information request processor for receiving, when information related to the IPTV service is requested from the content provider server, information requested from the IPTV network and transmitting the information to the content provider server; and an execution request processor for transmitting, when an execution request related to the IPTV service is transmitted from the content provider server, the execution request to the IPTV network.

According to another aspect of the present invention, there is provided a method of operating a Web service gateway connected to an IPTV network and a content provider server, including: transmitting, when IPTV service progress information is transmitted from the IPTV network, IPTV request notification corresponding to the progress information to the content provider server; controlling, when a request for an IPTV service is transmitted from the content provider server, the IPTV network so that the requested IPTV service is transmitted to an IPTV terminal; receiving, when information related to the IPTV service is requested from the content provider server, information requested from the IPTV network and transmitting the information to the content provider server; and transmitting, when an execution request related to the IPTV service is transmitted from the content provider server, the execution request to the IPTV network.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram illustrating a configuration of an IPTV system including a Web service gateway according to an exemplary embodiment of the present invention;

FIG. 2 is a diagram illustrating a configuration of the Web service gateway of FIG. 1;

FIG. 3 is a flowchart illustrating a method of operating an IPTV request notification processor in the Web service gateway of FIG. 2;

FIG. 4 is a flowchart illustrating a method of operating an IPTV service request processor in the Web service gateway of FIG. 2;

FIG. 5 is a flowchart illustrating a method of operating an nPVR processor in the Web service gateway of FIG. 2;

FIG. 6 is a flowchart illustrating a method of operating an IPTV profile excess processor in the Web service gateway of FIG. 2; and

FIG. 7 is a flowchart illustrating a method of operating a content control and management processor in the Web service gateway of FIG. 2.

### DETAILED DESCRIPTION OF THE INVENTION

Hereinafter, exemplary embodiments according to the present invention will be described in detail with reference to the accompanying drawings.

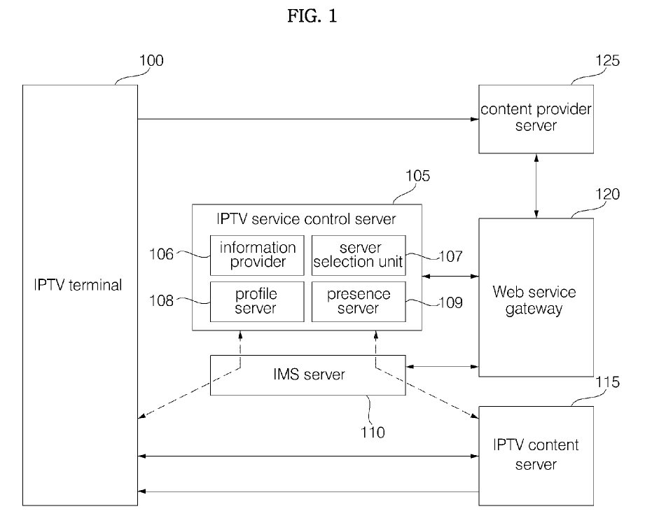

FIG. 1 is a diagram illustrating a configuration of an IPTV system including a Web service gateway according to an exemplary embodiment of the present invention;

As shown in FIG. 1, the IPTV system includes an IPTV terminal 100, an IPTV service control server 105, an IP multimedia subsystem server (IMS server) 110, an IPTV content server 115, a Web service gateway 120, and a content provider server 125.

The IPTV terminal 100 selects a program guide, a VOD list, and additional service information provided by the content provider server 125 through a HyperText Transfer Protocol (HTTP) and requests an IPTV service to the IPTV service control server 105 through the IMS server 110. The IPTV terminal 100 communicates with the IMS server 110 through a Session Initiation Protocol (SIP) and becomes a certification target of the IPTV service by the IMS server 110.

Here, an IPTV service that can be requested by the IPTV terminal 100 includes a VOD service, a channel broadcasting service, and a Web service and includes all IPTV services that can be provided by the content provider server 125.

The IPTV service control server 105 performs a function of an SIP receiving terminal with respect to a transmitted IPTV service request, performs content certification or server selection with respect to a VOD service, and selects group information allocated to a channel with respect to a channel broadcasting service, and performs session control with respect to a Network Personal Video Recorder (nPVR) service. Further, the IPTV service control server 105 performs a function of an IMS application server while performing communicating with the IMS server 110 through the SIP.

The IPTV service control server 105 includes an information provider 106 for providing a program guide and IPTV service information to the IPTV terminal 100, a server selection unit 107 for selecting an optimum IPTV content server with respect to a request for a service such as a VOD service, a channel broadcasting service, and an nPVR service, a profile server 108 for storing a content profile, a device profile, and a user profile for the IPTV service, and a presence server 109 for storing a user environment of an IPTV service and transmitting the stored user environment to a second user. The IPTV service control server 105 provides a personalized IPTV service through the presence server 109 and the profile server 108.

The IMS server 110 performs certification and routing, call session connection, and Quality of Service (QoS) control of the IPTV terminal 100. The IMS server 110 performs a function of transmitting a control message between the IPTV service control server 105, the IPTV content server 115, and the IPTV terminal 100.

The IPTV content server 115 provides the requested IPTV service to the IPTV terminal 100.

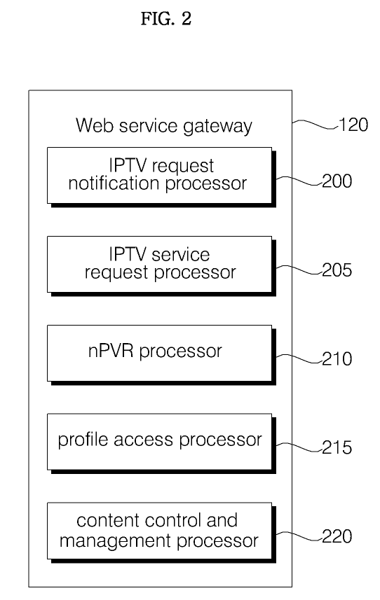

The Web service gateway 120 performs a function of a gateway between the content provider server 125 and the IMS based-IPTV network in order to use the Web-based content provider server 125 in an IMS based-IPTV network. The Web service gateway 120 communicates with the content provider server 125 through Simple Object Access Protocol Application Process Invocation (SOAP API) and communicates with the IPTV service control server 105 using the IMS server 110. The Web service gateway 120 communicates with the IMS server 110 through an SIP. Further, the Web service gateway 120 communicates with the presence server 109 through an SIP and communicates with the profile server 108 through an XML Configuration Access Protocol (XCAP). The Web service gateway 120 is described in detail later with reference to FIG. 2. The Web service gateway 120 provides various application services and easily secures contents, and allows a Web-based content provider to secure a good quality of IPTV network through opening of the IPTV network.

The content provider server 125 is a Web-based IPTV application/Web-based content provider, and a content provider is separate from an IPTV provider. The content provider server 125 provides a Web-based IPTV service to the IPTV terminal 100 through the Web service gateway 120.

FIG. 2 is a diagram illustrating a configuration of the Web service gateway of FIG. 1.

As shown in FIG. 2, the Web service gateway 120 includes an IPTV request notification processor 200, an IPTV service request processor 205, an nPVR processor 210, a profile access processor 215, and a content control and management processor 220.

The IPTV request notification processor 200 checks the IPTV service control server 105 and the IPTV content server 115 with respect to IPTV request notification transmitted from the IPTV terminal 100 and transmits the IPTV request notification corresponding to a progress situation of an IPTV service to the content provider server 125.

The IPTV service request processor 205 controls the IPTV service control server 105 and the IPTV content server 115 to provide the IPTV service to the IPTV terminal 100 with respect to an IPTV service request transmitted from the content provider server 125.

The nPVR processor 210 processes a request for an nPVR service or a request for nPVR information related to an nPVR service transmitted from the content provider server 125.

The profile access processor 215 processes a profile request for a content, a device, or a user transmitted from the Web-based content provider server 125.

The content control and management processor 220 processes a control request about content information storage, content management, content reproduction, stop, etc. transmitted from the content provider server 125.

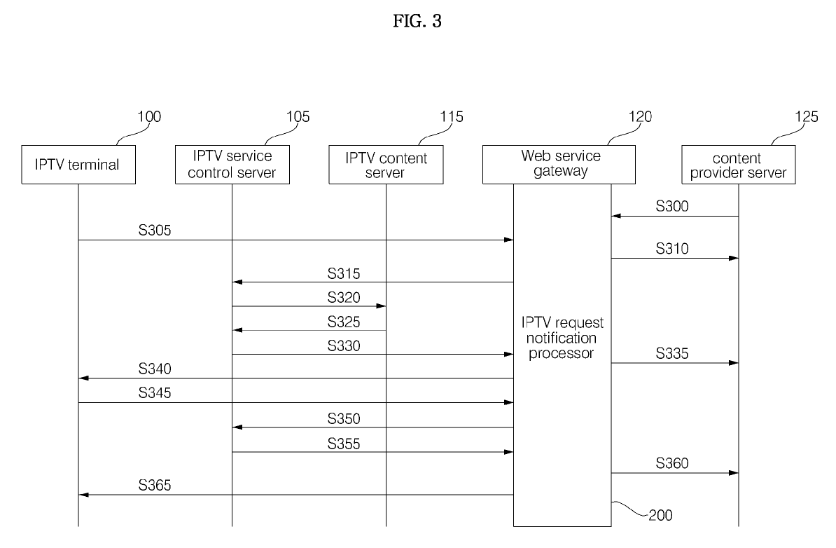

FIG. 3 is a flowchart illustrating a method of operating an IPTV request notification processor in the Web service gateway of FIG. 2.

As shown in FIG. 3, the content provider server 125 requests IPTV request notification to the IPTV request notification processor 200 (S300). When the IPTV terminal 100 requests an IPTV service to the IPTV service control server 105 through the IMS server 110, a request for the IPTV service is transmitted from the IPTV terminal 100 to the IPTV request notification processor 200 through the IMS server 110 (S305). The IPTV request notification processor 200 checks the transmitted IPTV service request and requests the IPTV service to the IPTV service control server 105, which is a destination of the IPTV service request (S315).

According to the kind of IPTV request notification requested at step S300, the IPTV request notification processor 200, having received a request for the IPTV service at step S300 transmits a message corresponding to the transmitted IPTV service request, for example, initial IPTV request notification to the content provider server 125 (S310).

The IPTV service control server 105, having received a request for the IPTV service at step S315 requests the IPTV service to the IPTV content server 115 (S320), and the IPTV content server 115, having received a request for the IPTV service transmits a response message for the IPTV service request to the IPTV service control server 105 (S325). The IPTV service control server 105, having received the response message transmits the response message to the IPTV request notification processor 200 (S330) and the IPTV request notification processor 200, having received the response message transmits the response message to the IPTV terminal 100 (S340).

According to the kind of IPTV request notification requested at step S300, the IPTV request notification processor 200, having received the response message for the IPTV service request at step S330 transmits a message corresponding to the transmitted response message, for example, connected IPTV request notification to the content provider server 125 (S335).

After the IPTV request notification is transmitted from the content provider server 125 to the IPTV request notification processor 200 at step S300, when the IPTV terminal 100, having received the IPTV service requests cancellation of the IPTV service to the IPTV service control server 105 through the IMS server 110, a request for IPTV service cancellation is first transmitted to the IPTV request notification processor 200 through the IMS server 110 (S345). The IPTV request notification processor 200 transmits the transmitted IPTV service cancellation request to the IPTV service control server 105 (S350). The IPTV service control server 105 transmits a response message for IPTV service cancellation to the IPTV request notification processor 200 (S355), and the IPTV request notification processor 200 transmits a response message for IPTV service cancellation to the IPTV terminal 100 (S365).

According to the kind of IPTV request notification requested at step S300, the IPTV request notification processor 200, having received a request for the IPTV service cancellation transmits a message corresponding to a response message for the transmitted IPTV service cancellation request at step S355, for example, released IPTV request notification to the content provider server 125 (S360).

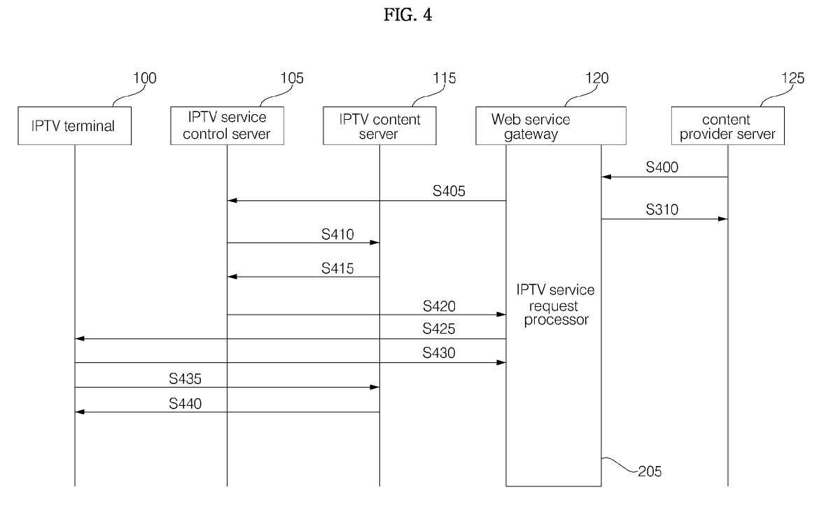

FIG. 4 is a flowchart illustrating a method of operating an IPTV service request processor in the Web service gateway of FIG. 2.

As shown in FIG. 4, the content provider server 125 requests an IPTV service to the IPTV service request processor 205 (S400). The requested IPTV service includes information about the IPTV terminal 100, information about a content ID, and information about a VOD service or a channel broadcasting service.

The IPTV service request processor 205, having received a request for an IPTV service transmits the IPTV service request to the IPTV service control server 105 (S405). For example, when information included in the requested IPTV service is a content ID, the IPTV service request processor 205 transmits a request for the IPTV service including the content ID to the IPTV service control server 105.

The IPTV service request processor 205 transmits the IPTV service request to the IPTV content server 115 (S410).

The IPTV content server 115, having received a request for the IPTV service transmits a response message for the IPTV service request to the IPTV service control server 105 (S415).

The IPTV service control server 105 transmits the transmitted response message to the IPTV service request processor 205 (S420).

The IPTV service request processor 205, having received the response message transmits a request for an IPTV service including content server information to the IPTV terminal 100 (S425).

The IPTV terminal 100 transmits a response message for the transmitted content server information to the IPTV service request processor 205 (S430).

When the response message is transmitted to the IPTV service request processor 205, the IPTV terminal 100 transmits a request for content reproduction to the IPTV content server 115 according to the content server information transmitted at step S425 (S435), and receives a content from the IPTV content server 115 (S440).

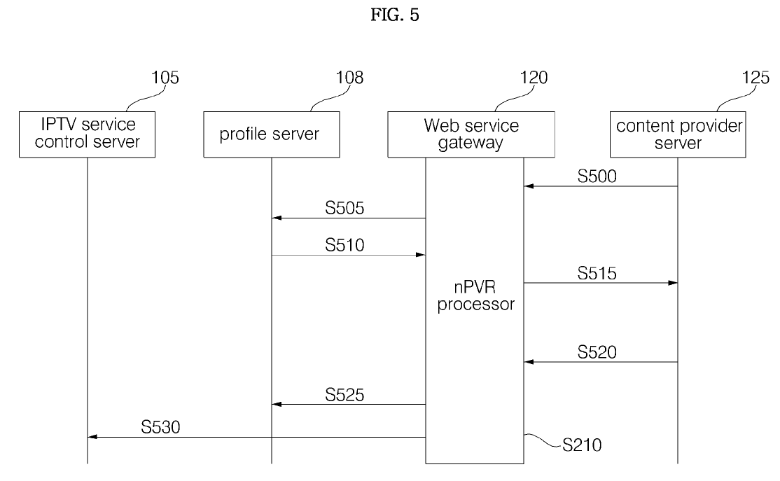

FIG. 5 is a flowchart illustrating a method of operating an nPVR processor in the Web service gateway of FIG. 2.

As shown in FIG. 5, the content provider server 125 requests information about nPVR to the nPVR processor 210 (S500). When the nPVR processor 210 transmits a request for the transmitted nPVR information to the profile server 108 (S505), the profile server 108 transmits the requested nPVR information to the nPVR processor 210 (S510). The nPVR processor 210, having received the nPVR information transmits the nPVR information to the content provider server 125 (S515).

When the content provider server 125 requests nPVR to the nPVR processor 210 (S520), the nPVR processor 210 requests the nPVR to the profile server 108 (S525) and requests the nPVR to the IPTV service control server 105 (S530).

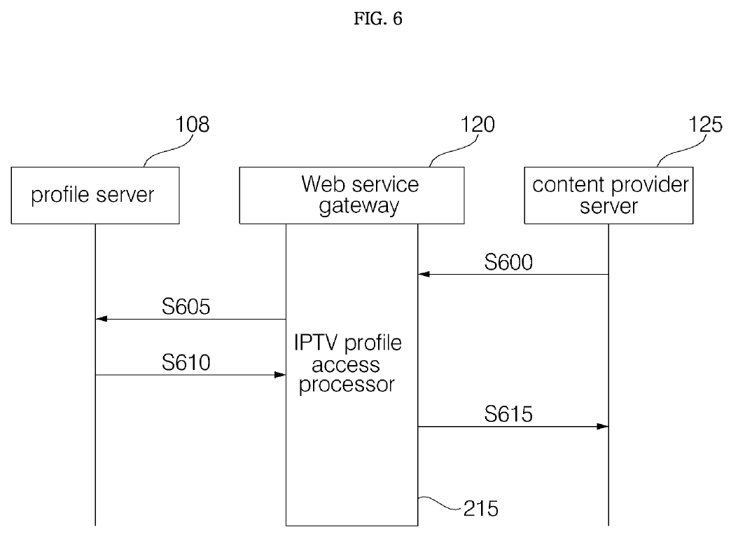

FIG. 6 is a flowchart illustrating a method of operating an IPTV profile excess processor in the Web service gateway of FIG. 2.

As shown in FIG. 6, the content provider server 125 requests an IPTV profile to the IPTV profile access processor 215 (S600). The IPTV profile includes IPTV terminal information and content information.

The IPTV profile access processor 215, having received a request for the IPTV profile requests the IPTV profile to the profile server 108 (S605), the profile server 108 transmits the requested profile to the IPTV profile access processor 215 (S610), and the IPTV profile access processor 215 transmits the transmitted profile to the content provider server 125 (S615).

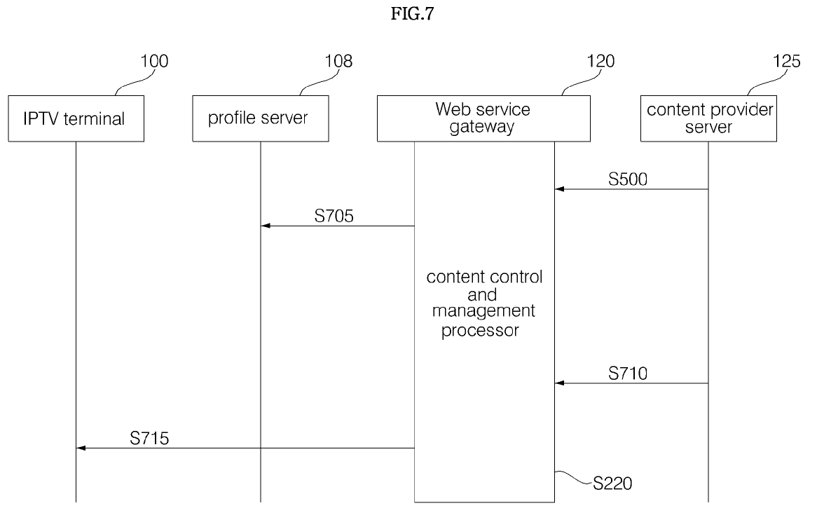

FIG. 7 is a flowchart illustrating a method of operating a content control and management processor in the Web service gateway of FIG. 2.

As shown in FIG. 7, when the content provider server 125 requests content management to the content control and management processor 220 (S700), the content control and management processor 220 transmits a request for content management to the profile server 108 (S705).

When the content provider server 125 requests content control to the content control and management processor 220 (S710), the content control and management processor 220 transmits a request for content control to the IPTV terminal 100 (S715).

The present invention can be implemented with processor readable codes in a processor readable recording medium. The processor readable recording medium includes all kinds of recording devices in which data that can be read by a processor are stored. The processor readable recording medium may include, for example, a ROM, a RAM, a CD-ROM, a magnetic tape, a floppy disk, and an optical data storage device. Further, the processor readable recording medium is distributed to a computer system connected to a network and may be stored and executed with a processor readable code in a distributed manner.

As described above, according to the present invention, by using a Web-based content provider, various IPTV services can be provided and by using an IPTV network of an IPTV provider, an IPTV network in which a quality is guaranteed can be provided to the content provider.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Web service gateway for an IPTV service, comprising:
an IPTV request notification processor for transmitting, when IPTV service progress information is transmitted from an IPTV network, IPTV request notification corresponding to the progress information to a content provider server;
an IPTV service request processor for controlling, when a request for an IPTV service is transmitted from the content provider server, the IPTV network so that the requested IPTV service is transmitted to an IPTV terminal;
an information request processor for receiving, when information related to the IPTV service is requested from the content provider server, information requested from the IPTV network and transmitting the information to the content provider server; and
an execution request processor for transmitting, when an execution request related to the IPTV service is transmitted from the content provider server, the execution request to the IPTV network.

2. The Web service gateway of claim 1, wherein the requested information comprises at least one of information related to a Network Personal Video Recorder.

3. The Web service gateway of claim 1, wherein the requested information is an IPTV profile.

4. The Web service gateway of claim 3, wherein the IPTV profile is at least one of a profile for a user, a profile for a content, and a profile for a device.

5. The Web service gateway of claim 1, wherein the execution request is one of a content management request and a content control request.

6. The Web service gateway of claim 1, wherein the execution request is a request for a Network Personal Video Recorder.

7. The Web service gateway of claim 1, wherein the content provider server provides a Web-based content.

8. The Web service gateway of claim 1, wherein the IPTV request notification processor receives the IPTV request notification from the content provider server.

9. The Web service gateway of claim 1, wherein the IPTV service progress information is at least one of an IPTV service request signal transmitted from the IPTV network, a response signal for an IPTV service request, and an IPTV service cancellation signal.

10. The Web service gateway of claim 1, wherein the IPTV service request processor receives a content ID from the content provider server.

11. A method of operating a Web service gateway connected to an IPTV network and a content provider server, comprising:
transmitting, when IPTV service progress information is transmitted from the IPTV network, IPTV request notification corresponding to the progress information to the content provider server;
controlling, when an IPTV service request is transmitted from the content provider server, the IPTV network so that the requested IPTV service is transmitted to an IPTV terminal;
receiving, when information related to the IPTV service is requested from the content provider server, information requested from the IPTV network and transmitting the information to the content provider server; and
transmitting, when an execution request related to the IPTV service is transmitted from the content provider server, the execution request to the IPTV network.

12. The method of claim 11, wherein the requested information comprises at least one of information related to a Network Personal Video Recorder.

13. The method of claim 11, wherein the requested information is an IPTV profile.

14. The method of claim 11, wherein the execution request is one of a content management request and a content control request.

15. The method of claim 11, wherein the execution request is a request for a Network Personal Video Recorder.

16. The method of claim 11, wherein the content provider server provides a Web-based content.
